(19) United States
(12) Patent Application Publication
(10) Pub. No.: US 2005/0122859 A1
(43) Pub. Date: Jun. 9, 2005

(54) Method and apparatus of mirror signal auto-calibration for optical disk drive

(75) Inventors: Yuh-Long Yeh, Taipei (TW); Chen-Hsing Lo, Taipei (TW)

Correspondence Address: BRUCE H. TROXELL;SUITE 1404, 5205 LEESBURG PIKE, FALLS CHURCH, VA, 22041, US

(73) Assignee: Ali Corporation

(21) Appl. No.: 10/856,760

(22) Filed: Jun. 1, 2004

(30) Foreign Application Priority Data
Dec. 9, 2003 (TW) 92134629

(51) Int. Cl. G11B 7/00

(52) U.S. Cl. 369/44.28; 369/124.01

(57) ABSTRACT

The present invention discloses a method and an apparatus of mirror signal auto-calibration for an optical disk drive, and the apparatus comprises a preamplifier and a MIRR signal calibrator, wherein the preamplifier is used for receiving the signal outputted from an optical head to produce a MIRR signal and feeds the MIRR signal to a seek speed controller for controlling a seeking operation of the optical head. The MIRR signal calibrator is used for receiving and evaluating the MIRR signal so as to output a calibration signal to a MIRR signal generator as the basis for generating the MIRR signal.

### FIELD OF THE INVENTION

The present invention relates to a method and apparatus of mirror signal auto-calibration, and more particularly, to a method and apparatus of mirror signal auto-calibration for optical disk drive capable of effectively generating correct mirror signals for enabling the optical head to locate a correct track without sliding during seeking.

### BACKGROUND OF THE INVENTION

During readout, the optical head of an optical disk drive needs to focus the laser beam thereof to a diffraction-limited spot, and onto an optical disk so as to perform the track-seeking and track-following operations between tracks of the optical disk. However, since the tracks of the optical disk is not an exact circle or due to the assembly of a loader, a considerable amount of extra electronics wizardry is needed to ensure that the laser stays in focus on the optical disk surface and that it follows the track it is reading. The forgoing condition is referred as “run out”. Therefore, a detection mechanism of the optical disk drive is used for detecting the “run out” and feedbacks the signal thereof for ensuring the optical head to perform track-seeking, track-following, and focusing normally.

Please refer to FIG. 5, which is a block diagram showing a track-seeking and track-following architecture of a conventional optical disk drive. Such architecture comprises an optical head 110, a preamplifier 125, a seek controller 150, a tracking controller 170, and a driver 160. Taking a seeking operation for example, while the optical head 110 is performing the seeking operation, some parameters are provided by software to a direction detection/hysteresis protection/remaining tracks controller 151 so as to assure the direction and the track number for the seeking.

The optical head 110 corresponds to the seeking action of the optical disk to output certain signals 115 to the preamplifier 125, and accordingly the preamplifier 125 will generate signals as following: track-error (TE) signal 143, mirror (MIRR) signal 145, track-error-zero-cross (TEZC) signal 146, and so on, and the TE signal 143 is being fed into the track controller 170, and the MIRR signal 145 along with the TEZC signal 146 is being fed into the direction detection/hysteresis protection/remaining tracks controller 151, and further the TEZC signal 146 is being fed into a speed calculator 175 of the seek controller 150.

Therefore, a seek speed controller 177 in the seek controller 150 will receive velocity error signal 185 formed by combining a signal 181 produced by a velocity profile generator 179 with an zero-cross-speed signal 183 produced by the speed calculator 175 according to the TEZC signal 146, and use the same as the feedback for controlling the velocity error while the optical head 110 is seeking.

However, the seeking direction of the optical head 110, the remaining number of track, and the hysteresis protection during slip is controlled by the direction detection/hysteresis protection/remaining tracks controller 151 based on both the phase of the MIRR signal 145 and the phase of the TEZC signal 146. In this regard, the direction detection/hysteresis protection/remaining tracks controller 151 outputs a corresponding output signal 153 to the seek speed controller 177.

Such that, the seek speed controller 177 can drive the driver 160 to control the optical head 110 to seek track at specific speed and direction, and carry out the hysteresis protection when sliding according to the velocity error signal 185 and the signal 153.

The focus of the present invention is the MIRR signal generated by a preamplifier 125. Please refer to FIG. 1, which is a schematic diagram depicting how a MIRR signal is generated. As seen in FIG. 1 with reference to FIG. 5, a signal 115 is being fed into the preamplifier 125 for enabling a MIRR source signal generator 126 to produce a MIRR source signal 136, and a MIRR slice level generator to produce a MIRR slice level signal 137, such that a MIRR signal 145 can be formed by synthesizing the MIRR source signal 136 and the MIRR slice level signal 137 using a comparator 128.

However, the nature of each optical disk and the carrying mechanism of the same will have affects on the signal 115 which is also the inputs of the MIRR source signal generator 126 and the MIRR slice level signal generator 127. Therefore, when the MIRR source signal 136 generated by the MIRR source signal generator 126 is sliced by the MIRR slice level signal 137 generated by the MIRR slice level signal generator 127 while both passing through the comparator 128, the slice level of the MIRR source signal 136 is inaccurate most of the time, and thus forming a MIRR signal 145 with phase error, i.e. the asymmetry duty cycle.

Therefore, in the condition that no feedback is being provided to the preamplifier 125 for forming the MIRR signal 145, an erroneous MIRR signal 145 is being outputted more than often while the optical head 110 is being used for reading different optical disk since the slice level of the MIRR source signal 136 generated by the MIRR source signal generator 126 is usually inaccurate. If the direction detection/hysteresis protection/remaining tracks controller 151 receives the erroneous MIRR signal 145 during optical head 110 is seeking, the seeking direction will be misjudged, a wrong track number is calculated, or a slide occurs at the end of the seeking while the hysteresis protection can not stop the slide, that is, the optical head 110 will jiggle unceasingly.

In view of the above description, the present invention discloses a method and an apparatus of mirror signal auto-calibration for optical disk drive to effectively generate correct mirror signals, such that the optical head can locate the correct track without sliding during seeking.

### SUMMARY OF THE INVENTION

The primary objective of the present invention is to provide an apparatus of mirror signal auto-calibration for optical disk drive, which comprises a preamplifier and a MIRR signal calibrator. The preamplifier is used for receiving the signal outputted from an optical head to produce a MIRR signal and feeds the MIRR signal to a seek speed controller for controlling the seeking of the optical head. The MIRR signal calibrator is used for receiving and evaluating the MIRR signal so as to output a calibration signal to a MIRR signal generator as the basis for generating the MIRR signal.

In a preferred embodiment of the present invention, the MIRR signal calibrator further comprises a detector and a calibrator. The detector is used for receiving and detecting the MIRR signal so as to output a result signal. The calibrator is used for receiving the result signal to output a calibrated signal. The detector could be a low pass filter or a counter.

Another objective of the present invention is to provide a method of mirror signal auto-calibration for optical disk drive, which comprises the step of: reading a MIRR signal; calibrating the MIRR signal while the upper and lower cycles of the same are not symmetric; and outputting the MIRR signal whose upper and lower cycles are symmetric as the basis for the optical head to perform a seeking operation.

Since the MIRR signal is formed from a MIRR source signal sliced with a slice level provided by a MIRR slice level signal, therefore, the method according to the preferred embodiment of the present invention further comprises the step of: calibrating the slice level for ensuring a MIRR signal to be formed with symmetric cycle, that is, if a slice level signal is too high that causes an asymmetry of the upper and lower cycles of the resulting MIRR signal, the slice level is adjusted to a lower level; and vice versa.

Accordingly, the method of the present invention further comprises a step of: Raising the waveform level of the MIRR source signal while a slice level signal is too high in order to enable the MIRR source signal to be sliced appropriately by the slice level; and vice versa.

Further, if the slice level is still high and has exceeded a certain limit after the same has been calibrated, then the calibrating process is terminated; or the calibration times of the slice level is larger than a threshold, the calibrating process is terminated.

In view of the description above, the present invention discloses a method and an apparatus of mirror signal auto-calibration for optical disk drive capable of using a feedback control mechanism for MIRR signal to effectively produce accurate MIRR signals, such that the optical head can locate the correct track without sliding during seeking.

### BRIEF DESCRIPTION OF THE DRAWINGS

FIG. 1 is a block diagram depicting a conventional apparatus of mirror signal generation for optical disk drive.

FIG. 2 is a block diagram depicting an apparatus of mirror signal auto-calibration for optical disk drive according to a preferred embodiment of the present invention.

FIGS. 3A is waveforms of the MIRR source signal and the tracking error signal of a preamplifier of FIG. 1.

FIG. 3B is waveforms of the MIRR signal and TEZC signal of a preamplifier of FIG. 1.

FIG. 4 is a flow chart of an apparatus of mirror signal auto-calibration for optical disk drive as depicted in FIG. 2 according to a preferred embodiment of the present invention.

FIG. 5 is a conventional seeking and tracking architecture of an optical disk drive.

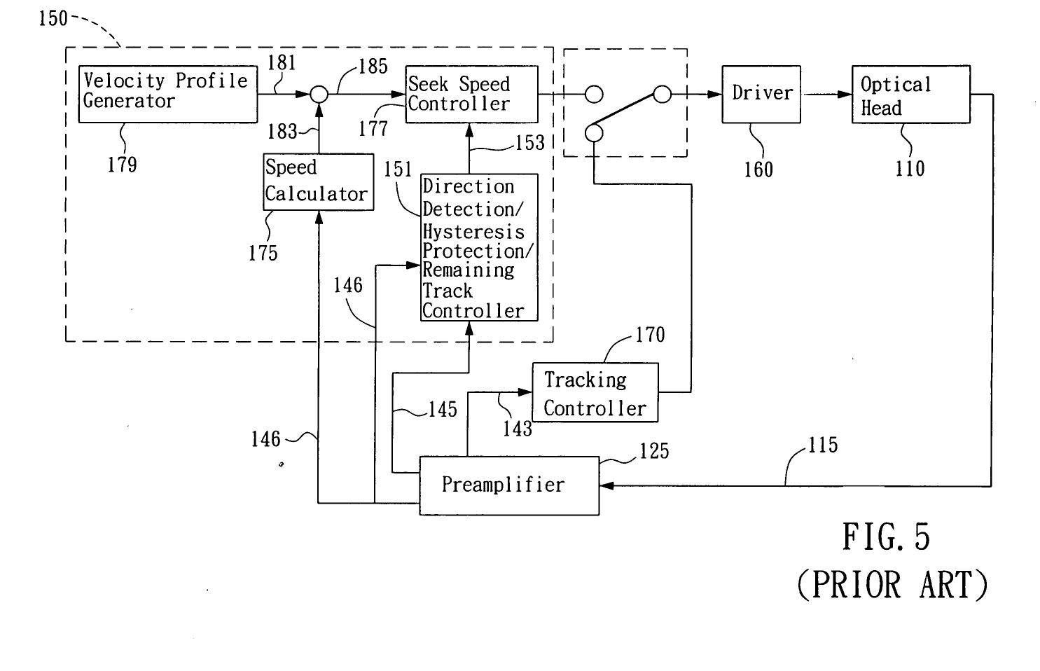

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows

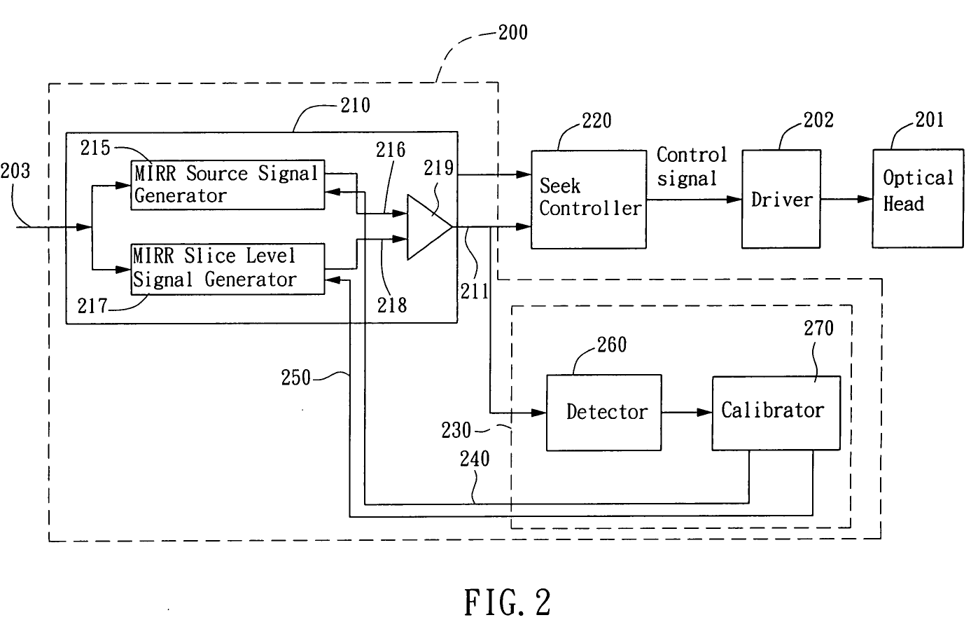

Please refer to FIG. 2, which is a block diagram depicting an apparatus of mirror signal auto-calibration for optical disk drive according to a preferred embodiment of the present invention. In FIG. 2, the apparatus 200 of mirror signal auto-calibration for optical disk drive comprises a preamplifier 210 and a MIRR signal calibrator 230, wherein the MIRR signal calibrator 230 receives a MIRR signal 211 generated by the preamplifier 210 and feeds back a calibration signal to be used for calibrating the MIRR signal 211 to an correct phase, that is, the upper and lower cycles are symmetrical.

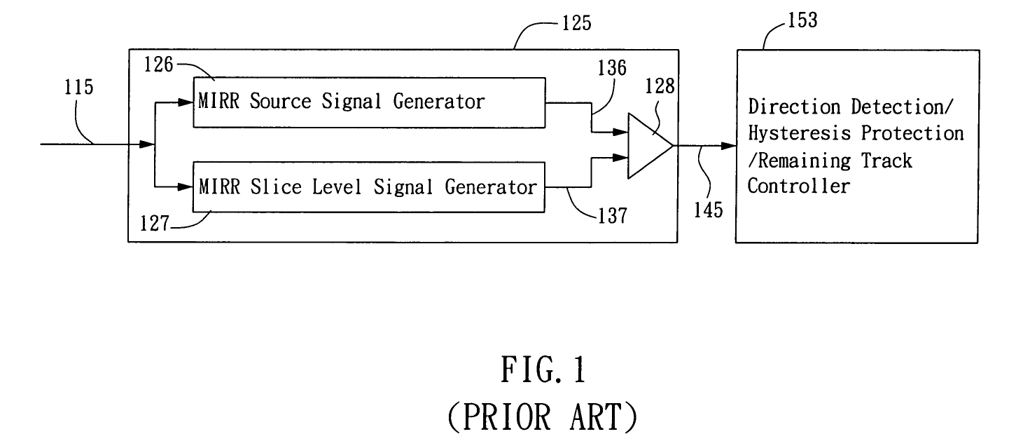

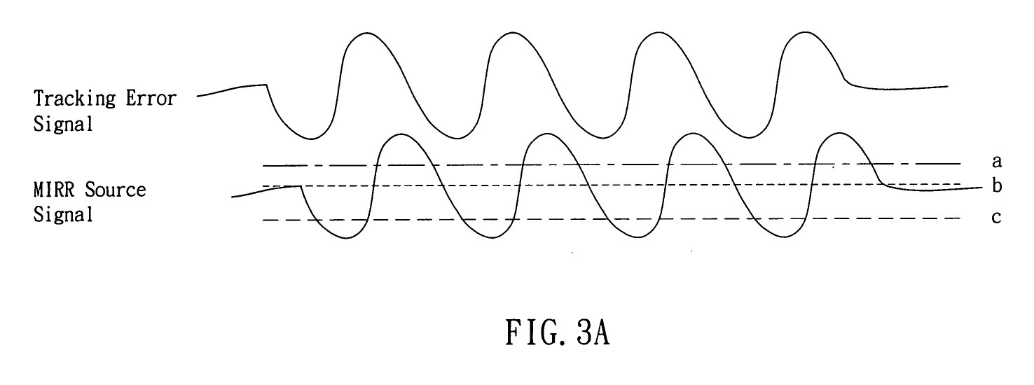

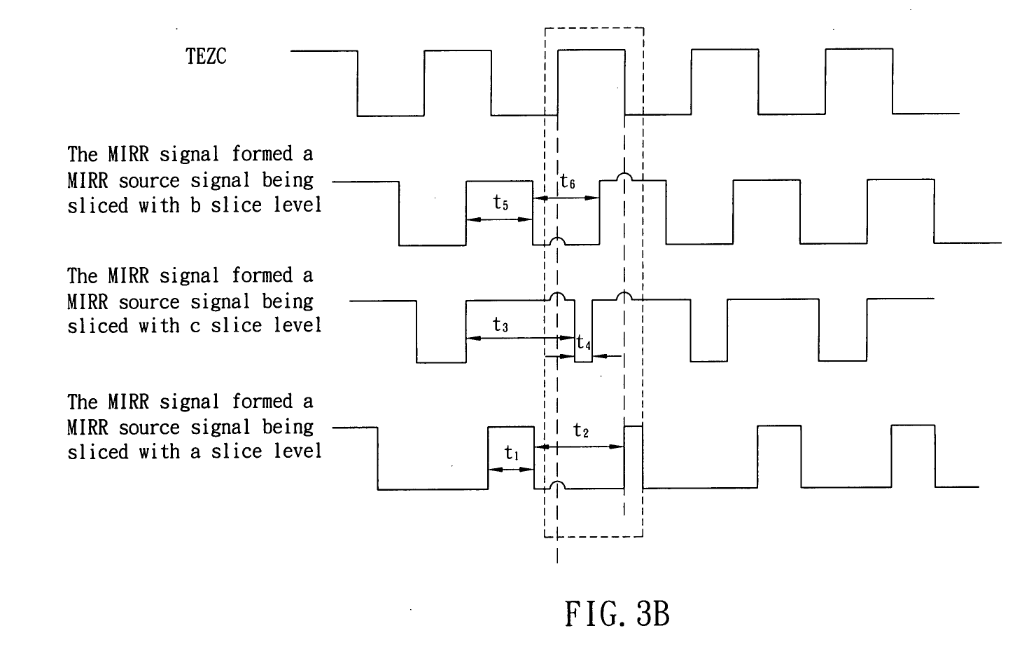

Please refer to FIG. 3A and FIG. 3B for the waveforms of a MIRR source signal 136 and a TEZC signal 146 of an amplifier 125 and the waveforms of a MIRR signal 145 and a TEZC signal 146 of the amplifier 125 respectively. In FIG. 3A, while comparing the MIRR signal 136 of FIG. 1 with a MIRR slice level signal 137 using a comparator 128, it is equivalent to pass the MIRR source signal 136 through a direct current level, e.g. levels a, b, and c as seen in FIG. 3B, and be sliced.

The MIRR signals 145 formed by a same MIRR source signal 136 being sliced respectively by levels a, b, and c is shown in FIG. 3B. If the MIRR slice level such, as level a, is too high, the period t1 of the upper half cycle of the formed MIRR signal 145 will be smaller than the period t2 of the lower half cycle of the MIRR signal 145. Similarly, if the MIRR slice level, such as level c, is too low, the period t3 of the upper half cycle of the MIRR signal 145 will be larger than the period t4 of the lower half cycle of the MIRR signal 145. Therefore, when the MIRR signal 145 and the TEZC signal 146 formed by using either level a or level c is used for controlling the seeking operation of the optical head 110 of FIG. 1, the unmatched phase problem happened between the MIRR signal 145 and the TEZC signal 146 will degrade the seeking operation.

If the MIRR slice level is correct, such as level b of FIG. 3B, the period t5 of the upper half cycle of the corresponding MIRR signal 145 will be equal to the period t6 of the lower half cycle, and the MIRR signal 145 formed by slicing the MIRR source signal 136 with level b is then a correct MIRR signal 145. Therefore, when the MIRR signal 145 and the TEZC signal 146 formed by using the level b is used for controlling the seeking operation of the optical head 110, the seeking operation can be performed accurately since the phase of the MIRR signal 145 matches that of the TEZC signal 146.

Please refer to FIG. 2, is a block diagram depicting an apparatus 200 of mirror signal auto-calibration for optical disk drive according to a preferred embodiment of the present invention. In this architecture, the foregoing issue of having an excessively high or low slice level is handled by using the MIRR signal calibrator 230 of the apparatus 200 to receive a MIRR signal 211 generated by the preamplifier 210 so as to produce calibration signals 240, 250 as feedback for controlling the calibration of the MIRR signal 211.

The method of mirror signal auto-calibration for optical disk drive using the apparatus 200 comprises the steps of: reading a MIRR signal 211; calibrating the MIRR signal 211 while the upper and lower cycles of the same are not symmetric; and outputting the calibrated MIRR signal whose upper and lower cycles are symmetric to a seek controller 220 as the basis for the optical head 210 to perform a seeking operation.

The MIRR signal 211 outputted from the preamplifier 210 is formed as following: a signal 203 outputted from an optical head 201 is being fed into the preamplifier 210 for enabling a MIRR source signal generator 215 therein to produce a MIRR source signal 216, and a MIRR slice level generator 217 to produce a MIRR slice level signal 218, such that a MIRR signal 211 can be formed by synthesizing the MIRR source signal 216 and the MIRR slice level signal 218 using a comparator 219. Therefore, the method of mirror signal auto-calibration for optical disk drive using the apparatus 200 for calibrating the MIRR signal 211 further comprises: If the MIRR slice level provided by the MIRR slice level signal 218 is too high or too low for slicing the MIRR source signal while compared the signals 216 and 218 by the comparator 219 and thus forms a MIRR signal 211 with asymmetric upper and lower half cycles, the MIRR signal calibrator 230 will produce calibration signals 250, 240 respectively for the MIRR slice level signal generator 217 and the MIRR source signal generator 215 to adjust some internal parameters thereof, and further calibrate the slice level of the MIRR slice level signal 218 outputted from the MIRR slice level signal generator 217 and the waveform level of the MIRR source signal 216 outputted from the MIRR source signal generator 215, such that the MIRR slice level provided by the MIRR slice level signal 218 is right for the MIRR source signal 216.

In view of the method of mirror signal auto-calibration for optical disk drive using the apparatus 200 as described above, the MIRR signal calibrator 230 comprises a detector 260 for detecting the upper and lower half cycles of the MIRR signal 211 and a calibrator 270 for evaluating and adjusting the symmetry of the upper and lower half cycles of the MIRR signal 211. In a preferred embodiment of the present invention, the detector can be a low pass filter consisted of resistors and capacitors or digital counter which outputs a result signal 280 to the calibrator 270 after detecting the MIRR signal 211. The low pass filter will rectify the waveform of the MIRR signal 211 into a voltage signal to reflect the symmetry of the upper and lower half cycles of the MIRR signal 211. The counter can directly count the upper and lower half cycles of the MIRR signal 211 to reflect the symmetry of the upper and lower half cycles of the MIRR signal 211. The calibrator 270 controls and outputs the calibration signals 240, 250 respectively to the slice level signal generator 217 and the MIRR source signal generator 215 according to the result signal 280.

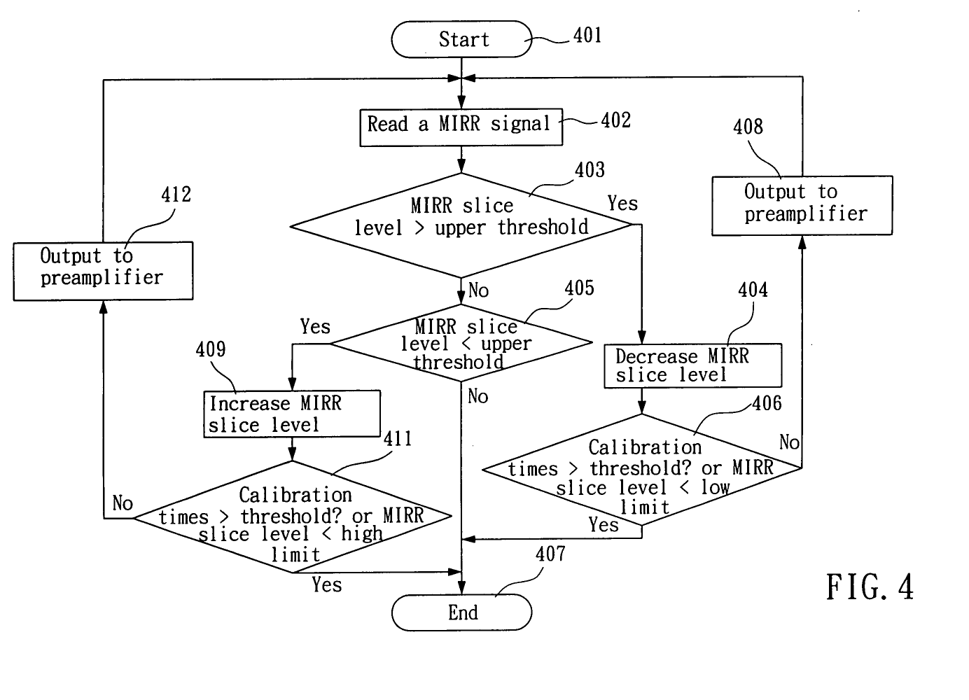

Please refer to FIG. 4, which is a flow chart of an apparatus 200 of mirror signal auto-calibration for optical disk drive as depicted in FIG. 2 according to a preferred embodiment of the present invention. Flow begins at block 401 where a MIRR signal 211 is being produced by the preamplifier 210. Flow then proceeds to block 402. At block 402, the detector 260 arranged inside the MIRR signal calibrator 230 starts to read the MIRR signal 211 outputted from the preamplifier 210.

At decision block 403, an evaluation is made to determine if the slice level of the MIRR source signal 216 is too high according to the following operations: the upper and lower half cycles of the MIRR signal 211 are computed by a low pass filter 260 and a counter 290 in the detector 260 so as to be used by the calibrator 270 to check if the upper and lower half cycles of the MIRR signal 211 are symmetric or not. If the slice level for the MIRR source signal 216 is too high, then flow is directed to block 404. If not, then flow proceeds to decision block 405. At block 404, a calibration signal 250 is being outputted from the MIRR signal calibrator 230 to the MIRR slice level generator 217 for decreasing the MIRR slice level of the MIRR slice level signal 218 and providing the same to the MIRR source signal 216. Flow then proceeds to decision block 406. At decision block 406, an evaluation is made to determine if the criteria for terminating the calibration are fulfilled, i.e. the upper and lower cycles of the MIRR signal 211 are symmetric. If yes, then flow is directed to block 407 and stopped. If not, then flow is directed to block 408. At block 408, a calibration signal 250 is being outputted from the calibrator 270 to the preamplifier 125 that is used for adjusting the MIRR slice level of the MIRR source signal 216 provided by the MIRR slice level signal 240.

At decision block 405, an evaluation is made to determine if the slice level of the MIRR source signal 216 is too low. If the MIRR slice level is too low, then flow is directed to block 409. If not, then flow is directed to block 407 and stop. At block 409, a calibration signal 250 is being outputted from the MIRR signal calibrator 230 to the MIRR slice level generator 217 for raising the MIRR slice level of the MIRR slice level signal 218 and providing the same to the MIRR source signal 216. Flow then proceeds to decision block 411. At decision block 411, an evaluation is made to determine if the criteria for terminating the calibration are fulfilled, i.e. the upper and lower cycles of the MIRR signal 211 are symmetric. If yes, then flow is directed to block 407 and stopped. If not, then flow is directed to block 412. At block 412, a calibration signal 250 is being outputted from the calibrator 270 to the preamplifier 125 that is used for adjusting the MIRR slice level of the MIRR source signal 216 provided by the MIRR slice level signal 240.

Further, the termination criteria of the whole process are not limited to the above. For example, when the number of calibration reaches an threshold, or when the MIRR slice level reaches a certain limit, the whole process can be terminated to prevent the process from being continued unceasingly, which will affect the seeking operation of the optical disk drive.

By the above-mentioned procedure, an apparatus 200 of mirror signal auto-calibration for optical disk drive can effectively calibrate the MIRR slice level signal 240 to produce an accurate MIRR signal 21 1 for the optical head 201 to perform the seeking operation on an optical disk 205, and such apparatus 200 also has a complete set of operation mechanism.

To sum up, the present invention discloses a method and an apparatus of mirror signal auto-calibration for optical disk drive capable of using a feedback control mechanism for MIRR signal to effectively produce accurate MIRR signals, such that the optical head can locate the correct track without sliding during seeking.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An apparatus of mirror signal auto-calibration for an optical disk drive, comprising:
a preamplifier, for receiving the signal outputted from an optical head to produce a MIRR signal and feeds the MIRR signal to a seek speed controller for controlling a seeking operation of the optical head; and
a MIRR signal calibrator, for receiving and evaluating the MIRR signal so as to output a calibration signal to a MIRR signal generator as the basis for generating the MIRR signal.

2. The apparatus of claim 1, wherein the MIRR signal calibrator further comprises:
a detector, for receiving the MIRR signal and detecting the upper and lower half cycles of the same so as to output a result signal; and
a calibrator, for receiving and evaluating the result signal so as to output the calibration signal.

3. The apparatus of claim 2, wherein the detector is a low pass filter.

4. The apparatus of claim 3, wherein the low pass filter is consisted of a plurality resistors and a plurality of capacitors.

5. The apparatus of claim 2, wherein the detector is a counter.

6. The apparatus of claim 5, wherein the preamplifier further comprises:
a MIRR source signal generator, for receiving a signal outputted from the optical head and the calibration signal to generate a MIRR source signal;
a MIRR slice level signal generator, for receiving the signal outputted from the optical head and the calibration signal to generate a MIRR slice level signal; and
a comparator, for receiving the MIRR source signal and the MIRR slice level signal to output the MIRR signal.

7. A method of mirror signal auto-calibration for an optical disk drive, comprising the steps of:
reading a MIRR signal;
calibrating the MIRR signal while the upper and lower cycles of the same are not symmetric; and
outputting the MIRR signal whose upper and lower cycles are symmetric as a basis for the optical head to perform a seeking operation

8. The method of claim 7, wherein the MIRR signal is formed by providing a MIRR slice level of a MIRR slice level signal to a MIRR source signal.

9. The method of claim 8 further comprising the step of: calibrating the slice level to a lower level if the slice level is too high and causes an asymmetry of the upper and lower cycles of the MIRR signal so as to ensure the MIRR signal to be formed with symmetric cycle.

10. The method of claim 8 further comprising the step of: calibrating the waveform level of the MIRR source signal if the slice level is too high and causes an asymmetry of the upper and lower cycles of the MIRR signal so as to ensure the MIRR signal to be formed with symmetric cycle.

11. The method of claim 9 further comprising the step of: terminating the calibrating of the slice level if the calibrated slice level reaches an upper limit.

12. The method of claim 8 further comprising the step of: calibrating the slice level to a higher level if the slice level is too low and causes an asymmetry of the upper and lower cycles of the MIRR signal so as to ensure the MIRR signal to be formed with symmetric cycle.

13. The method of claim 12 further comprising the step of: calibrating the waveform level of the MIRR source signal if the slice level is too low and causes an asymmetry of the upper and lower cycles of the MIRR signal so as to ensure the MIRR signal to be formed with symmetric cycle.

14. The method of claim 12 further comprising the step of: terminating the calibrating of the slice level if the calibrated slice level reaches an lower limit.

15. The method of claim 13 further comprising the step of: terminating the calibration of the MIRR slice level when the number of the calibration reaches a threshold.
